(19) United States
(12) Patent Application Publication
(10) Pub. No.: US 2015/0304644 A1
(43) Pub. Date: Oct. 22, 2015

(54) 3-DIMENSIONAL IMAGE DISPLAY APPARATUS

(71) Applicant: KOREA INSTITUTE OF SCIENCE AND TECHNOLOGY, Seoul (KR)

(72) Inventors: Sung Kyu KIM, Seoul (KR); Hyoung LEE, Gyeongsangbuk-Do (KR)

(21) Appl. No.: 14/321,982

(22) Filed: Jul. 2, 2014

(30) Foreign Application Priority Data
Apr. 21, 2014 (KR) 10-2014-0047502

(51) Int. Cl. H04N 13/04; G02B 27/22

(52) U.S. Cl. CPC H04N 13/0447; G02B 27/225; H04N 13/0402

(57) ABSTRACT

Provided is a 3D image display apparatus, which configures a light path such that light sources radiated from at least two projection optical systems pass through any one point (or nodal point) formed before the imaging position and forms a viewing zone having at least two viewing points at each observation position. Thereby, fixing a ratio of a degree of overlap (crosstalk) between neighbor viewing zones according to each depth sense (or observation distance) behind the imaging position, establishing a 3D viewing environment suitable for an observer, and enabling the observer to view a multi-view and super multi-view image. In addition, by merging the adjacent viewing points within one viewing zone, it is possible to minimize an area in which the viewing zones are overlapped and uniformize the intensity of light representing an image.

### CROSS-REFERENCE TO RELATED APPLICATION

This application claims priority to and the benefit of Korean Patent Application No. 2014-0047502, filed on Apr. 21, 2014, the disclosure of which is incorporated herein by reference in its entirety.

### BACKGROUND

1. Field of the Invention

The present invention relates to a three-dimensional (3D) image display apparatus, and more particularly, to a multi-view or super multi-view 3D image display apparatus that establishes a 3D viewing environment suitable for an observer by fixing an overlap (crosstalk) ratio between adjacent viewing zones according to an observation distance when forming a viewing zone having at least two viewing points at an observation position.

2. Discussion of Related Art

In general, in order to commercialize a 3D image display apparatus or 3D TV, it is, above all, important to provide viewers with a natural stereoscopic perception without fatigue and allow multiple viewers to have a wide viewing zone.

In addition, when a 3D image is shown to a viewer or audience, a factor causing resistance or fatigue, that is, a human factor should be considered. 3D image display apparatuses are classified into a “glasses” type 3D image display apparatus that needs special glasses and a “non-glasses” type or autostereoscopic 3D image display apparatus that does not need special glasses.

However, the “non-glasses” type 3D image display apparatus having two viewing points has a limitation in that a viewing zone capable of viewing an image is excessively limited. To overcome this limitation, 3D image display apparatuses having a multi-view or super multi-viewing zone have been developed. Representative examples of the 3D image display apparatuses include a lenticular lens type and a parallax barrier type.

However, according to the lenticular lens type and the parallax barrier type, the overlap ratio is high between viewing zones of adjacent viewing points. Thereby, degrading an image quality of an implemented 3D image, limiting a 3D viewing zone due to a limitation of resolution of a flat panel display apparatus, and degrading resolution of a unit viewing point image of a 3D image as the number of viewing points increases. Accordingly, a viewer cannot view natural 3D images while moving.

A multi-view 3D image display apparatus is disclosed in Korean Patent Publication No. 10-2011-0024062 in order to overcome this limitation. The multi-view 3D image display apparatus includes a projection optical system for outputting light, and the projection optical system is arranged in a horizontal or vertical direction to form an imaging pixel for generating a 3D image having at least two viewing points at an imaging position.

However, since the 3D image display apparatus has the overlap (crosstalk) ratio varying between neighboring viewing zones depending on an observation distance, the 3D image display apparatus gives little inconvenience to observers. FIG. 1 shows crosstalk according to an observation distance in a 3D image display apparatus according to the related art. Referring to FIG. 1, in observation distances 1 and 2 before an optimal observation position, a crosstalk ratio between viewing zones is not fixed. Accordingly, this results in that the crosstalk ratio varies with the observation distance. Accordingly, a technology for minimizing an area of crosstalk generated between viewing zones and uniformizing intensity of light by merging adjacent viewing points in one viewing zone is required to fix a crosstalk that varies with a viewing distance.

Accordingly, in order to limit these limitations, a multi-view or super multi-view 3D image display apparatus is needed.

### SUMMARY OF THE INVENTION

The present invention is directed to a 3D image display apparatus that can view an optimal multi-view or super multi-view image by fixing an overlap (crosstalk) ratio between neighboring viewing zones according to an observation distance to establish a 3D viewing environment suitable for an observer when a viewing zone having at least two viewing points is formed at an observation position.

The present invention is also directed to a 3D image display apparatus that can minimize an area of crosstalk occurring between viewing zones and uniformizing intensity of light by merging adjacent viewing points in one viewing zone.

According to an aspect of the present invention, there is provided a 3D image display apparatus including: two or more projection optical systems arranged in a horizontal or vertical direction and configured to output light; and a controller configured to use a nodal point where two light rays meets, the two light rays, each defining an outermost ray of the light corresponding to unit pixels radiated from the respective projection optical systems, perform an arrangement such that the nodal points of the unit pixels are matched with each other from the two or more projection optical systems, and configure a light path such that a viewing zone having at least two viewing points is formed at an observation position behind an imaging position.

Each of the two or more projection optical systems may include: a display unit configured to display an image; and a plurality of projection lenses disposed to be spaced a certain distance from the display unit and configured to refract light radiated from any one pixel of the display unit to form an image pixel for generating a 3D image at the imaging position.

The projection lenses provided in the two or more projection optical systems may be disposed such that the light traveling from the any one pixel of the display unit to the projection lenses is projected into effective diameters of the projection lenses or commonly projected into all pixels in a specific area.

The projection lenses provided in the two or more projection optical systems may be disposed such that effective diameters of the projection lenses are in substantial contact with each other without any gap. The projection lenses provided in the two or more projection optical systems may be disposed such that effective diameters of the projection lenses are substantially overlapped with each other.

A degree of overlap between neighboring viewing zones may be adjusted by adjusting a distance between the effective diameters of the projection lenses provided in the two or more projection optical systems.

The apparatus may further include a vertical diffuser disposed at the imaging position or between the imaging position and the nodal point formed before the imaging position and configured to provide a vertical viewing zone.

The light radiated from the two or more projection optical systems may be expanded through the imaging position to form a multi-view viewing zone between the two outermost light rays of the light.

The two or more projection optical systems may include at least one of a digital micromirror device (DMD), a liquid crystal display (LCD), a ferro liquid crystal display (FLCD), and a liquid crystal on silicon (LCOS) image display device.

The controller may find a distance from the imaging position to the nodal point formed before the imaging position by using a projection distance from the two or more projection optical systems to the imaging position, a size of an image at the projection lenses provided in the two or more projection optical systems, and a size of an image at the imaging position, and perform control such that the light radiated from the two or more projection optical systems passes through the any one point formed before the imaging position. A distance DI from the imaging position to the nodal point formed before the imaging position may be found from the following Equation:

$$\overline{DI = \frac{\begin{matrix}PP \text{:} DP = PI \text{:} DI \\ ( D - DI ) \times PI\end{matrix}}{PP}} \\ \underline{DI = \frac{D \times PI}{( PP + PI )}} \qquad ( Equation )$$

where DP is the projection distance from the two or more projection optical systems to any one point formed before the imaging position, PP is the size of an image at the projection lenses provided in the two or more projection optical systems, and PI is the size of an image at the imaging position.

The controller may merge and flatten the light radiated from the two or more projection optical systems, thereby minimizing crosstalk between the viewing points or minimizing a change in brightness of a viewing point image around a center of the viewing point.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating crosstalk according to an observation distance in a 3D image display apparatus according to the related art;

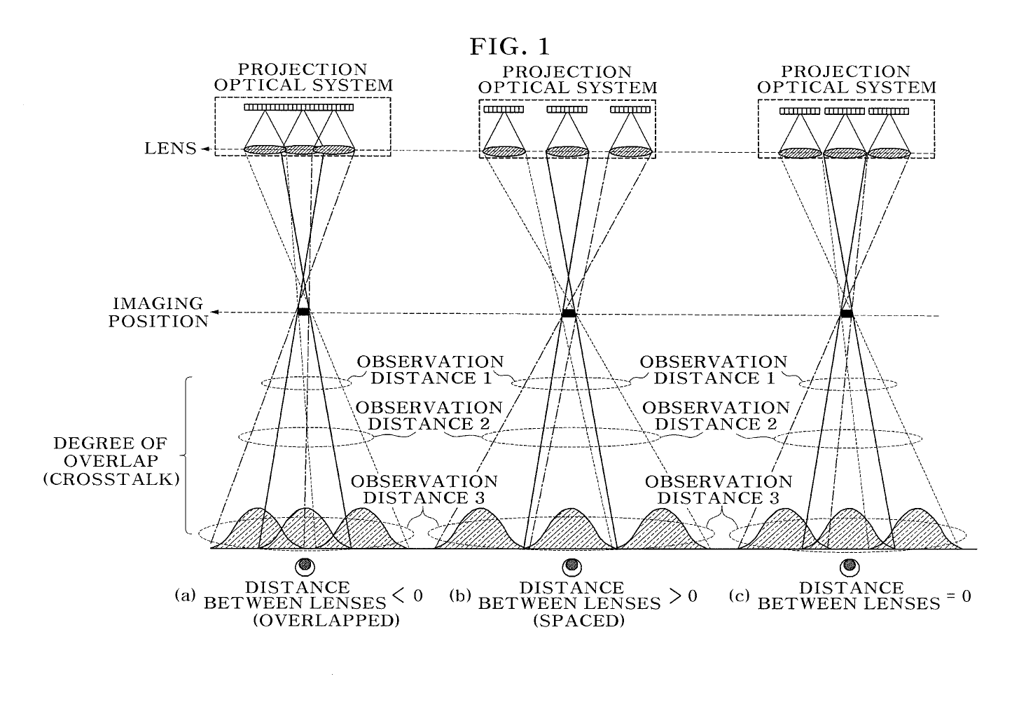

FIG. 2 is a concept diagram schematically illustrating a 3D image display apparatus according to an embodiment of the present invention;

FIG. 3 is a diagram illustrating a geometrical relationship for finding a nodal point of light radiated from a projection optical system according to an embodiment of the present invention;

FIG. 4 is a diagram illustrating a change in crosstalk according to a light path and a light observation distance of a 3D image display apparatus forming three viewing points when there is no distance between lenses of the projection optical system according to an embodiment of the present invention (distance between diameters of lenses through which light passes=0);

FIG. 5 is a diagram illustrating a change in crosstalk according to a light path and a light observation distance of a 3D image display apparatus forming three viewing points when distances between lenses of the projection optical system are overlapped with each other according to another embodiment of the present invention (distance between diameters of lenses through which light passes <0);

FIG. 6 is a diagram illustrating a change in crosstalk according to a light path and a light observation distance of a 3D image display apparatus forming three viewing points when distances between lenses of the projection optical system are separated from each other according to still another embodiment of the present invention (distance between diameters of lenses through which light passes>0);

FIG. 7 illustrates a shape of a viewing zone formed at each observation distance by light radiated from a projection optical system to pass through any one point before an imaging point according to an embodiment of the present invention;

FIG. 8 is a diagram illustrating a theory showing a merging effect on two viewing points and an experimental result obtained by merging a viewing zone distribution formed at each observation distance of light radiated from two projection optical systems according to an embodiment of the present invention;

FIG. 9 illustrates the formation of each viewing zone by light radiated from a plurality of projection optical systems to pass through any one point formed before an imaging position according to an embodiment of the present invention;

FIG. 10 is a diagram illustrating a shape of a viewing zone formed at each observation distance, which is obtained through an experiment, when light is designed to pass through an imaging position using a 3D image display apparatus according to the related art; and

FIG. 11 is a diagram illustrating a shape of a viewing zone formed at each observation distance, which is obtained through an experiment, when light is designed to pass through one point (nodal point) in front of an imaging point, using a 3D image display apparatus according to an embodiment of the present invention.

### DETAILED DESCRIPTION OF EXEMPLARY EMBODIMENTS

Hereinafter, embodiments of the present invention will be described in detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

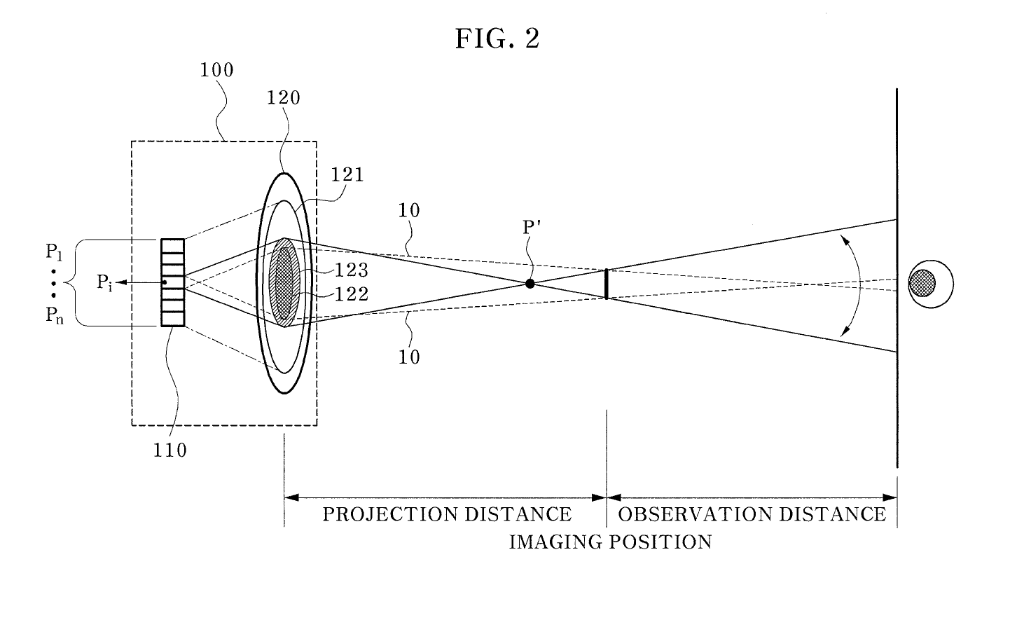

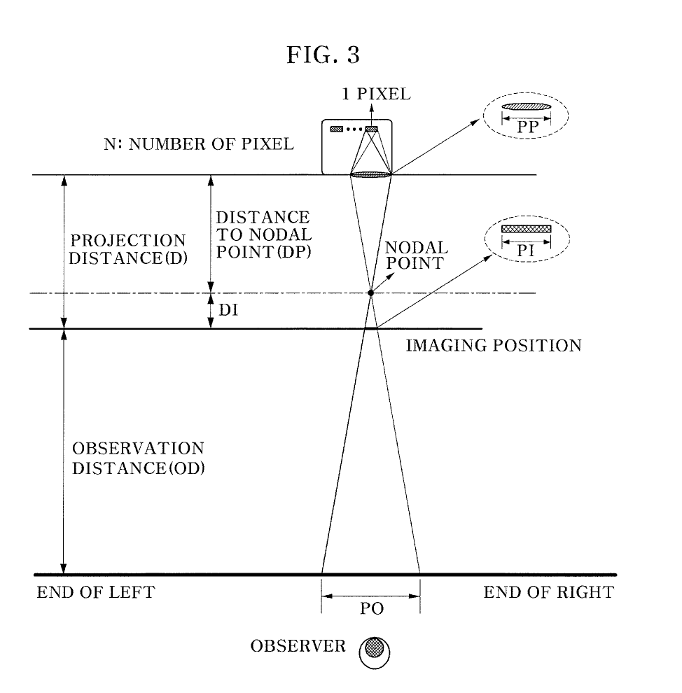

FIG. 2 is a concept diagram schematically illustrating a 3D image display apparatus according to an embodiment of the present invention, and FIG. 3 shows a geometrical relationship for finding a nodal point of light radiated from a projection optical system according to an embodiment of the present invention.

FIGS. 2 and 3 are conceptual diagrams illustrating a configuration and a principle of the 3D image display apparatus according to an embodiment of the present invention and, for convenience of description, schematically show an example using a single projection optical system 100. However, a 3D image display apparatus according to another embodiment of the present invention may include at least two projection optical systems 100 that output light.

Referring to FIGS. 2 and 3, an optical path is formed such that light is radiated from the projection optical system 100 sequentially passes through any one point (or nodal point) P′ before an imaging position and forms a viewing zone having a viewing point at an observation position.

Here the projection optical system 100 includes a display unit 110 configured to display a 2D image and a projection lens 120 spaced a certain distance from the display unit 110 and configured to refract light radiated from pixels P1 to Pn of the display unit 110 to form an image pixel for generating a 3D image at the imaging position.

The projection lens 120 may be disposed such that light is radiated at a certain angle from a pixel Pi (in an example of FIG. 2) selected from among pixels P1 to Pn of the display unit 110 to pass through an effective diameter 121 for the display unit 110 of the projection lens 120, and each pixel may be disposed such that the light passes a common effective diameter 122 in an effective diameter 123. The projection lens 120 may be configured as a group of lenses including a convex lens and a concave lens in order to enhance optical characteristics of the projection optical system. Here, the effective diameter 121 is a maximum diameter in the projection lens through which light rays generated from all pixels illustrated in FIG. 2 pass.

Examples of the projection optical system 100 may include at least one of a digital micromirror device (DMD), a liquid crystal display (LCD), a ferro liquid crystal display (FLCD), and a liquid crystal on silicon (LCOS) image display device.

That is, FIG. 2 is a diagram illustrating a path along which light travels from any one pixel of the display unit 110 of the single projection optical system 100, and in which the display unit 110 included in the single projection optical system 100 is simply described as pixels P1 to Pn arranged vertically (or horizontally). The light from any pixel Pi of the display unit 110 may be projected at a certain angle into the effective diameter 121 of the projection lens 120, and all the pixels may be disposed such that the light is projected into the common effective diameter 122. As shown in FIG. 2, outermost light rays 10 radiated from the pixel Pi are projected at a certain angle into the effective diameter 122 of the projection lens 120 to form an image of the pixel at an imaging position. Thus, the image formed at the imaging position may be viewed at the observation position. The light rays having passed through the imaging position may form an outer boundary of each optical distribution, and an area between two outer boundaries may form a viewing zone for the pixel. The viewing zone may be formed based on the effective diameter 121.

FIG. 3 is a diagram for finding a nodal point P′ of light radiated from a single projection optical system 100 including projection lenses 120 having the effective diameter 122, and a distance DI from an imaging position to any one point (or nodal point) P′ formed before the imaging position may be seen from Equations 1 and 2 below. First, D is calculated by Equation 1 below:

D=DP+DI (Equation 1)

If D is calculated, DI is induced by substituting D into Equation 2 below:

$$\overline{DI = \frac{\begin{matrix}PP \text{:} DP = PI \text{:} DI \\ ( D - DI ) \times PI\end{matrix}}{PP}} \\ \underline{DI = \frac{D \times PI}{( PP + PI )}} \qquad ( Equation 2 )$$

where DP is a projection distance from each of at least two projection optical systems to a point formed before the imaging position, PP is the effective diameter 121 or 122 in a projection lens provided in each of at least two projection optical systems, and PI is a size of an image at the imaging position.

For example, if the effective diameter PP occupied in the projection lens is approximately 25 mm, the projection distance D is 600 mm, and the size PI of an image at the imaging position is approximately 1 mm, it can be seen by Equation 1 that a distance DI from the imaging position to one point formed before the imaging position is approximately 23.07 mm.

At least two projection optical systems, each of which is schematically described in FIGS. 2 and 3, may be arranged in a horizontal direction or a direction where a viewing zone forms such that the light passes through any one point P′ formed before the imaging position and then generates a 3D image. In this case, the 3D image display apparatus may include at least two projection optical systems and a controller (not shown), and the controller may perform control such that light is radiated from the two or more projection optical systems 100 to pass through any one point P′ foil led before the imaging position, using a projection distance D from each of the two or more projection optical systems, a width PP of a diameter of a projection lens through which the light is radiated from the display unit provided in the two or more projection optical systems to pass, a size PI of an image at the imaging position, and a distance DI from the imaging position to any one point P′ formed before the imaging position.

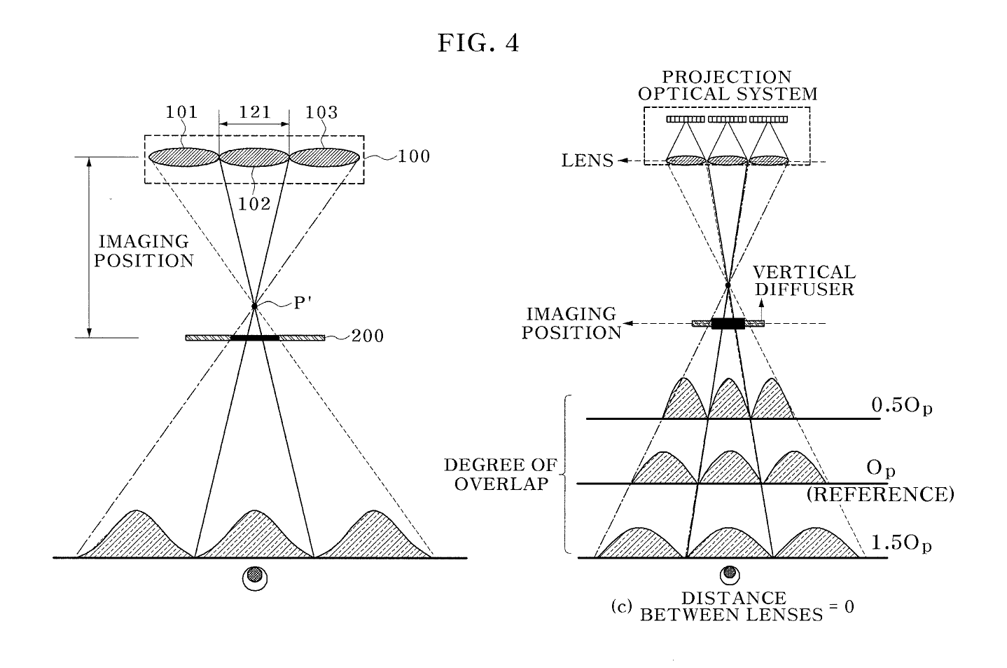

FIG. 4 is a diagram illustrating a change in crosstalk according to a light path and a light observation distance of a 3D image display apparatus forming three viewing points according to an embodiment of the present invention. In FIG. 4, the projection optical system 100 of the 3D image display apparatus forming three viewing points is shown, but the present invention is not limited thereto. For example, if the number of projection optical systems, which corresponds to the number of viewing points intended to be formed, is increased to, for example, 4, a viewing zone may include another multi-view point (for example, four-view point).

Referring to FIG. 4, the first to third projection optical systems 101 to 103 are simply described as projection lenses having the effective diameter corresponding to the effective diameter 121 or 122 of FIG. 2. In an embodiment of the present invention, the first to third projection optical systems 101 to 103 may be disposed such that the effective diameters of the projection lenses are in substantial contact with each other without any gap.

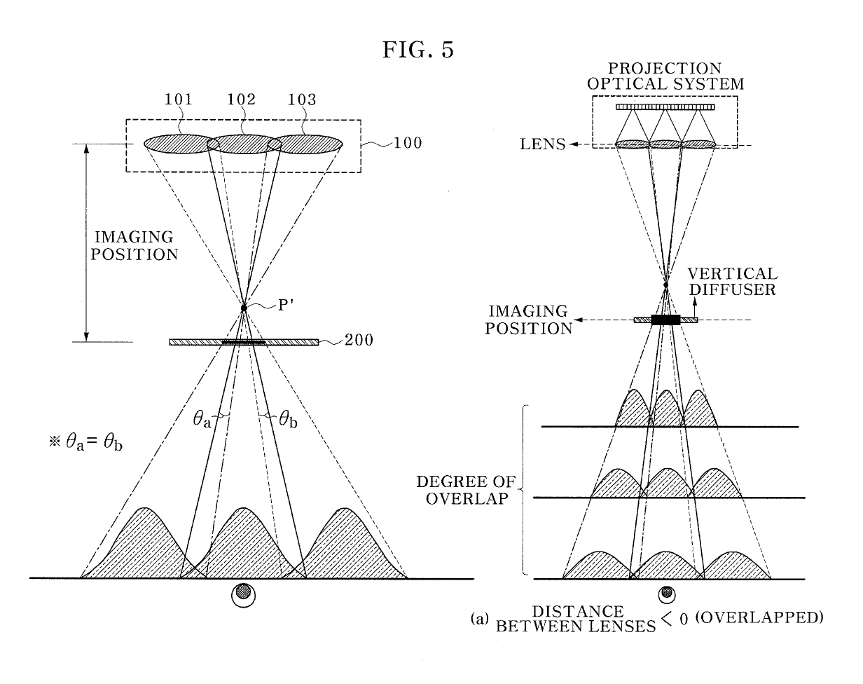

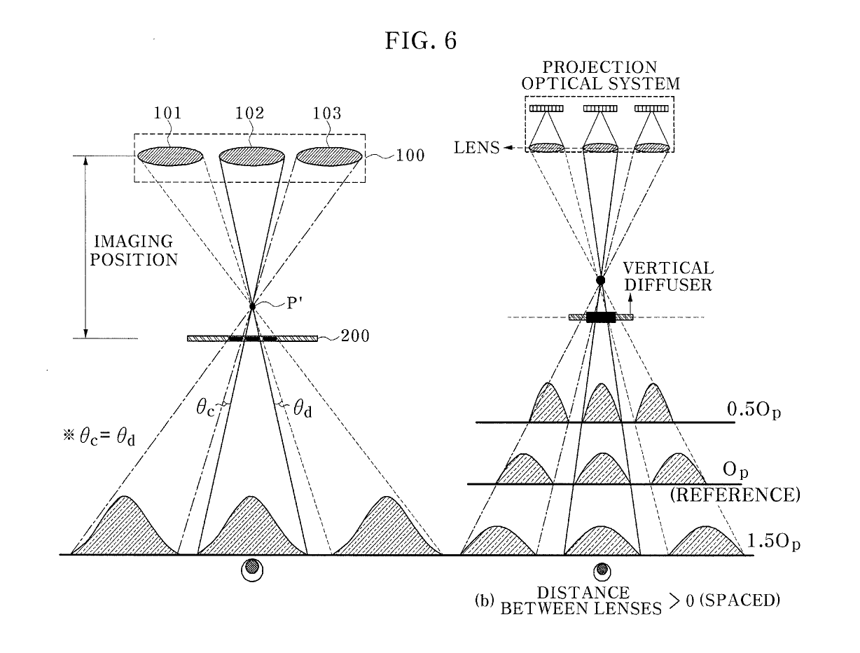

In particular, in an embodiment of the present invention, a vertical diffuser 200 may be further disposed between an imaging position and a nodal point P′ formed before the imaging point to form a viewing zone in a vertical direction. Preferably, as shown in FIG. 4, a vertical viewing zone may be secured by disposing the vertical diffuser at a depth of the imaging position. The position setting for the vertical diffuser may be applied to FIGS. 5 and 6 below.

As shown in FIG. 4, the outermost ray of light output from the first projection optical system 101 is light indicated as a dashed line. The outermost ray output of light output from the second projection optical system 102 is light indicated as a solid line. The outermost ray output of light output from the third projection optical system 103 is light indicated as a dashed dotted line.

The outermost rays of light radiated from the first to third projection optical systems 101 to 103 may pass through an imaging position and then form respective viewing zones. The viewing zones of FIG. 4 can minimize an area of crosstalk that is generated by overlap with an adjacent viewing zone. As shown in the right side of FIG. 4, though an area of the viewing zone increases as the viewing zone is further from the imaging position, a ratio of the crosstalk area is allowed to be fixed, thereby minimizing change in an overlap ratio between viewing points in a direction of depth easily and efficiently compared to the existing method, and thus implementing multi-view and super multi-view viewing zones.

FIG. 5 is a diagram illustrating a change in crosstalk according to a light path and a light observation distance of a 3D image display apparatus forming three viewing points according to another embodiment of the present invention. Referring to FIG. 5, a viewing zone having three viewing points, and which is formed when each distance between projection lenses having effective diameters of the first to third projection optical systems 101 to 103 is less than zero (overlap), is illustrated.

Referring to FIG. 5, as above described in FIG. 4, the first to third projection optical systems 101 to 103 are simply described as projection lenses having the effective diameter corresponding to the effective diameter 121 or 122 of FIG. 2. In another embodiment of the present invention, the first to third projection optical systems 101 to 103 may be disposed such that the effective diameters of the projection lenses are substantially overlapped. That is, the first to third projection optical systems 101 to 103 may be disposed such that the effective diameters of the projection lenses overlap each other and a distance therebetween is greater or less than a width of one imaging pixel formed at the imaging position.

In FIG. 5, θₐ and θ_{b} are each a degree of overlap with an adjacent viewing zone, and in this case, θₐ is equal to θ_{b}. As shown in the right side of FIG. 5, a ratio of crosstalk to light amount according to change in depth of an observation position is fixed, such that a uniform image may be always provided to an observer.

FIG. 6 is a diagram illustrating change in crosstalk according to a light path and a light observation distance of a 3D image display apparatus forming three viewing points according to still another embodiment of the present invention. Referring to FIG. 6, a viewing-zone having three viewing points, and which is formed when each distance between projection lenses having effective diameters of the first to third projection optical systems 101 to 103 is greater than zero (spaced), is illustrated.

Referring to FIG. 6, as above described in FIGS. 4 and 5, the first to third projection optical systems 101 to 103 are simply described as projection lenses having the effective diameter corresponding to the effective diameter 121 or 122 of FIG. 2.

In still another embodiment of the present invention, the first to third projection optical systems 101 to 103 may be disposed such that the effective diameters of the projection lenses have a certain distance. Each of θ_{c} and θ_{d} indicates a distance between adjacent viewing zones, and in this case θ_{c} is equal to θ_{d}. As shown in the right side of FIG. 6, the distance between the viewing zones may be maintained at a certain ratio according to an observation depth position.

As described above, the first to third projection optical systems 101 to 103 in embodiments of FIGS. 4 to 6 form light paths that pass through any one point P′ formed before the imaging position such that pixels are arranged in parallel at the imaging position, and each light passing through the imaging position forms a respective viewing zone. It is possible to easily adjust a degree of overlap between neighboring viewing zones by adjusting the distance between the effective diameters 121 or 122 of the projection lenses provided in the first to third projection optical systems 101 to 103.

Considering that the distance between the eyes of a typical adult is about 65 mm, a viewing zone having a little degree of overlap may be formed according to characteristics of the observer, or a certain degree of overlap may be included or not, thereby allowing a multi-view and super multi-view implementation.

In addition, a light path is formed such that light passes through any one point P′ formed before the imaging position, it is advantageous that a degree of overlap may be observed at a certain ratio according to the distance in the viewing zone formed by the light passing through the imaging position. In addition, a problem in which resolution decreases as the number of viewing points increases may be mitigated.

Since an existing multi-view or super multi-view 3D image display apparatus using a lenticular lens or parallax barrier divides total pixels of a flat panel display panel by a desired number of multi-viewing points, a resolution of a unit viewing point may be degraded in inverse proportion to the number of viewing points. However, it is possible to prevent the degradation of resolution of the unit viewing point by using a number, which corresponds to the number of viewing points, of projection optical systems.

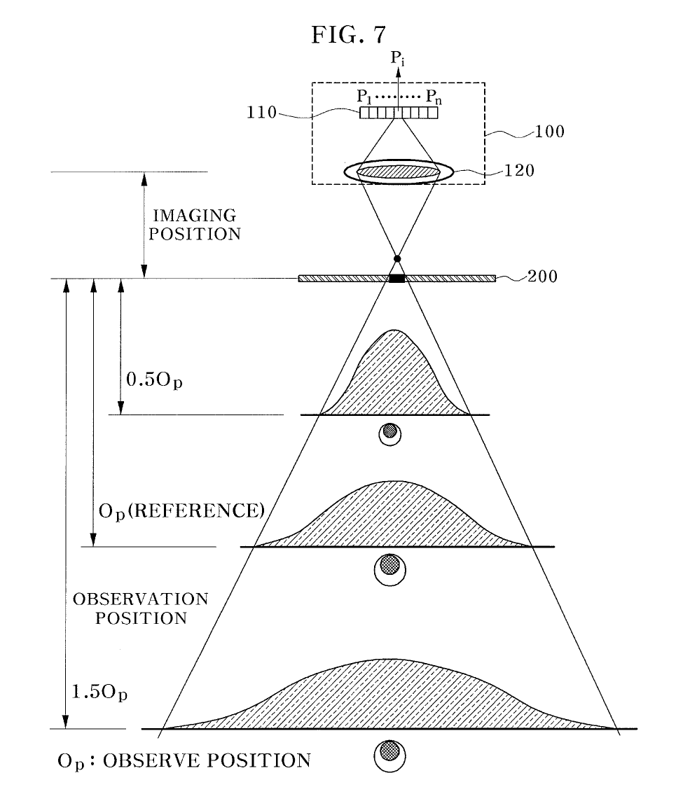

FIG. 7 illustrates a shape of a viewing zone formed at each observation distance by light radiated from a projection optical system applied to an embodiment of the present invention to pass through any one point before an imaging point, and illustrates a shape of a viewing-zone formed according to an observation distance from a simplified projection optical system 100.

Referring to FIG. 7, light radiated from the simplified projection optical system 100 forms one pixel at the imaging position and forms a viewing zone at each observation position. Through the shape of the viewing zone formed in the above-described method, as the observation distance is increased, the brightness is reduced.

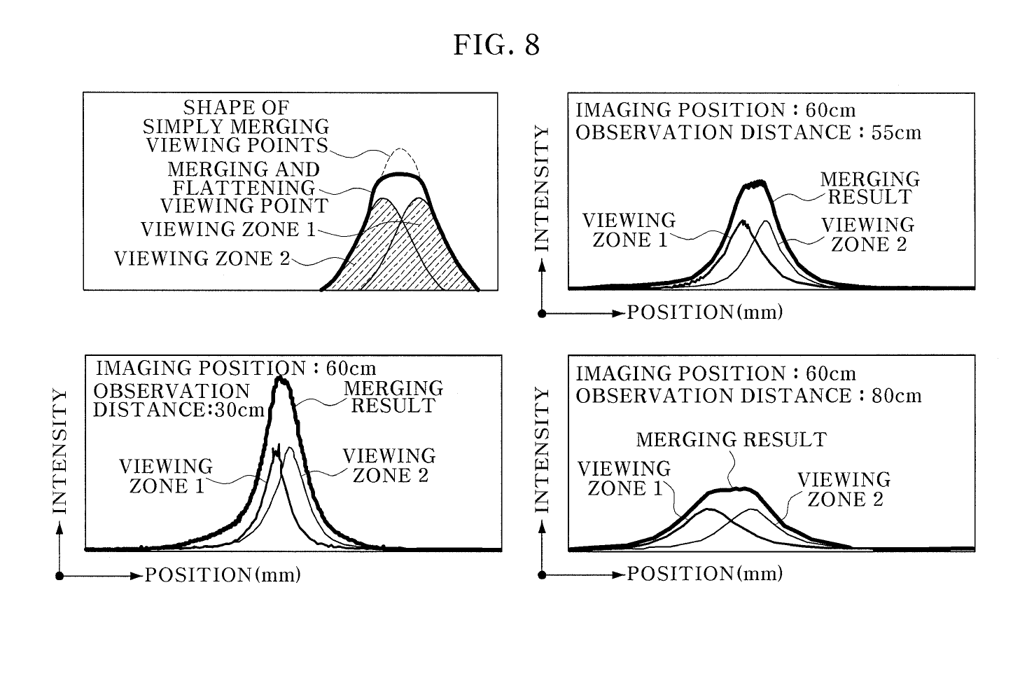

FIG. 8 is a diagram illustrating information about merging viewing zones obtained at each observation position by light radiated from the projection optical system according to an embodiment of the present invention.

Referring to FIG. 8, if two viewing zone distributions obtained at each observation position by light radiated from two projection optical systems are merged or flattened, crosstalk between viewing points is decreased and also crosstalk at the center of each viewing point. Furthermore, a brightness of a viewing point observed with a single eye increases and becomes uniform. Due to this effect, when a multi-view 3D image display apparatus is implemented, crosstalk for an entire image may be improved, brightness of the image may be increased, and more importantly a change in brightness at the center of the viewing zone may be reduced.

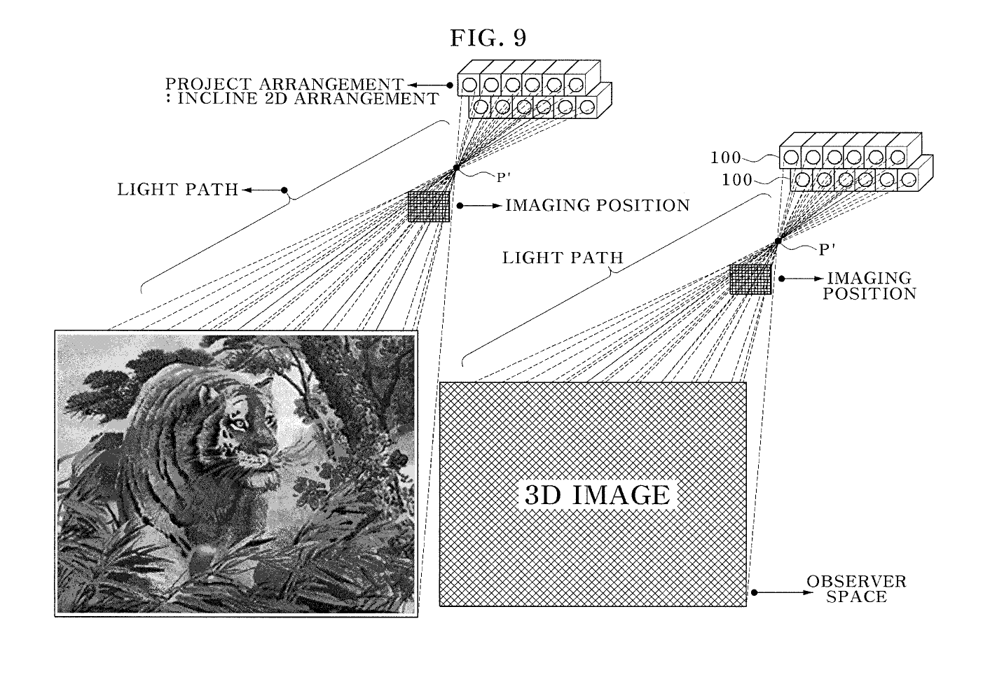

FIG. 9 illustrates forming each viewing zone by light radiated from a plurality of projection optical systems applied to an embodiment of the present invention to pass through any one point before an imaging position. In addition, it can be seen that more viewing points may be implemented in a limited horizontal width by applying a vertical arrangement in addition to a horizontal arrangement.

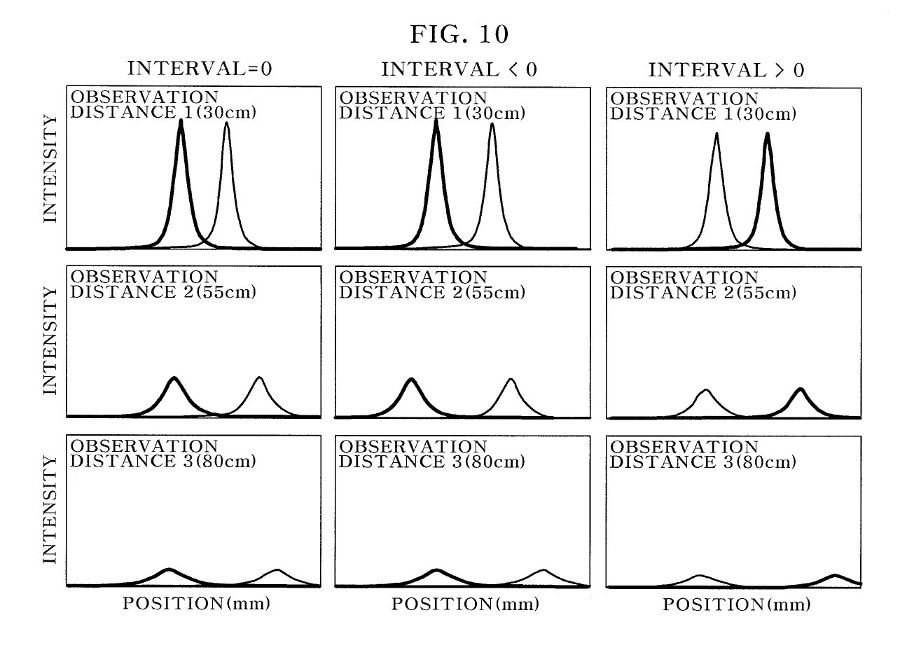

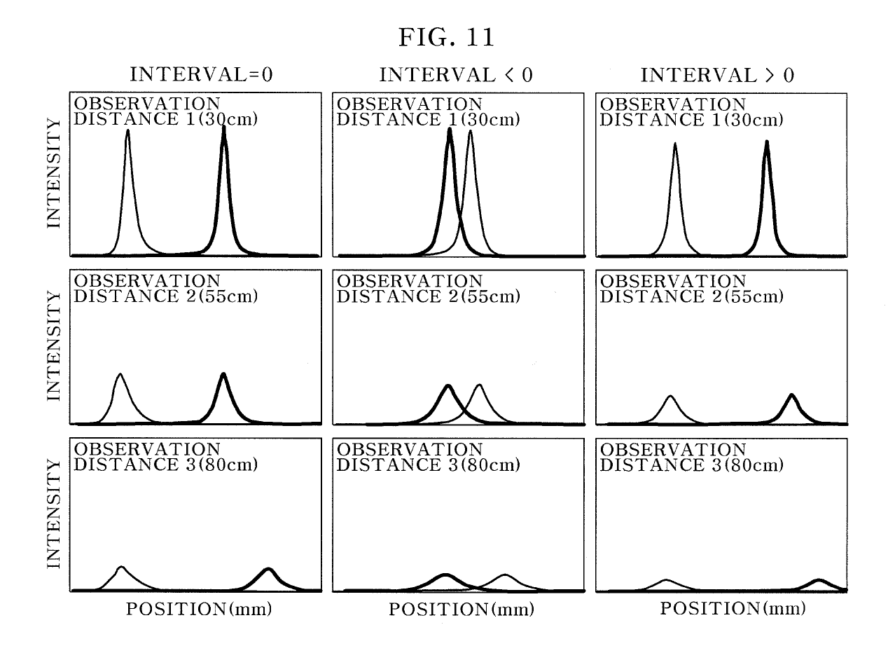

FIGS. 10 and 11 are diagrams illustrating experimental data about the shape of the viewing zone formed at each observation distance in order to compare the 3D image display apparatus according to an embodiment of the present invention with the 3D image display apparatus according to the related art.

FIG. 10 is a diagram illustrating the shape of the viewing zone formed at each observation distance (for example, 30 cm, 55 cm, and 80 cm) by the light radiated from two projection optical systems to pass through the imaging position in the conventional 3D image display apparatus according to the related art. FIG. 10 illustrates a case in which the distance between the projection lenses having effective diameters of the two projection optical systems is zero (interval=0), a case in which the distance between the projection lenses having effective diameters of the two projection optical systems is less than zero (interval<0), and a case in which the distance between the projection lenses having effective diameters of the two projection optical systems is greater than zero (interval>0), respectively.

As illustrated in FIG. 10, when the conventional 3D image display apparatus according to the related art is applied, it can be seen that a convergence ratio between neighboring viewing zones differs according to the observation position.

FIG. 11 is a diagram illustrating the shape of the viewing zone formed at each observation distance (for example, 30 cm, 55 cm, and 80 cm) by the light radiated from two projection optical systems to sequentially pass through any one point formed before the imaging position and then the imaging position in the 3D image display apparatus according to an embodiment of the present invention. FIG. 11 shows a case in which the distance between the projection lenses having effective diameters of the two projection optical systems is zero (interval=0), a case in which the distance between the projection lenses having effective diameters of the two projection optical systems is less than zero (interval<0), and a case in which the distance between the projection lenses having effective diameters of the two projection optical systems is greater than zero (interval>0), respectively.

As illustrated in FIG. 11, when the 3D image display apparatus according to an embodiment of the present invention is applied, it can be seen that a ratio of crosstalk to light amount of the viewing zone at each observation position is constant irrespective of the observation distance.

According to the 3D image display apparatus as described above, it is advantageously possible to fix a ratio of a degree of overlap (crosstalk) between neighbor viewing zones according to each depth sense (or observation distance) behind the imaging position, establish a 3D viewing environment suitable for an observer, and enable the observer to view a multi-view and super multi-view image, by configuring a light path such that light sources radiated from at least two projection optical systems pass through any one point (or a nodal point) formed before the imaging position and form a viewing zone having at least two viewing points at each observation position.

It is also advantageously possible to fix a ratio of a degree of overlap between neighboring viewing zones to a light amount of the viewing zone at each observation position and form a multi-view viewing zone for a 3D image, by allowing light radiated from at least two projection optical systems to pass through any one point before the imaging point.

It is also advantageously possible to adjust a degree of overlap (crosstalk) between neighboring viewing zones, which generally occurs in the 3D image display apparatus, by adjusting a distance between the projection optical systems.

It is also advantageously possible to minimize a degree of overlap of an image according to an observation distance or allow desired crosstalk to occur in a certain area since a degree of overlap of an image is fixed according to a position of an observer.

It is also advantageously possible to improve a degree of overlap for an entire image, increase brightness of the image, and minimize a change in brightness in a viewing-point center area, by merging with a neighboring viewing zone. It is also advantageously possible to overcome degradation of resolution for each unit viewing point, which occurs at a multi-view or super multi-view viewing point.

While the preferred embodiments of the 3D image display apparatus according to an embodiment of the present invention, the present invention is not limited thereto, various modifications may be made therein, and the appended claims are intended to cover all such modifications which may fall within the spirit and scope of the invention.

What is claimed is:

1. A three-dimensional (3D) image display apparatus comprising:
two or more projection optical systems arranged in a horizontal or vertical direction and configured to output light; and
a controller configured to use a nodal point where two light rays meet, the two light rays, each defining an outermost ray of the light corresponding to unit pixels radiated from the projection optical systems, perform an arrangement such that the nodal points of the unit pixels are matched with each other from the two or more projection optical systems, and configure a light path such that a viewing zone having at least two viewing points is formed at an observation position behind an imaging position.

2. The apparatus of claim 1, wherein each of the two or more projection optical systems comprises:
a display unit configured to display an image; and
a plurality of projection lenses disposed to be spaced a certain distance from the display unit and configured to refract light radiated from any one pixel of the display unit to form an image pixel for generating a 3D image at the imaging position.

3. The apparatus of claim 2, wherein the projection lenses provided in the two or more projection optical systems are disposed such that the light traveling from any one pixel of the display unit to the projection lenses is projected into effective diameters of the projection lenses, or the light traveling from all the pixel of the display unit to the projection lenses is projected commonly in a specific area.

4. The apparatus of claim 2, wherein the projection lenses provided in the two or more projection optical systems are disposed such that effective diameters of the projection lenses are in substantial contact with each other without any gap.

5. The apparatus of claim 2, wherein the projection lenses provided in the two or more projection optical systems are disposed such that effective diameters of the projection lenses are substantially overlapped with each other.

6. The apparatus of claim 2, wherein a degree of overlap between neighboring viewing zones is adjusted by adjusting a distance between the effective diameters of the projection lenses provided in the two or more projection optical systems.

7. The apparatus of claim 1, further comprising a vertical diffuser disposed at the imaging position or between the imaging position and the nodal point formed before the imaging position and configured to provide a vertical viewing zone.

8. The apparatus of claim 1, wherein the light radiated from the two or more projection optical systems is expanded through the imaging position to form a multi-view viewing zone between the two outermost light rays of the light.

9. The apparatus of claim 1, wherein the at least two projection optical systems include at least one of a digital micromirror device (DMD), a liquid crystal display (LCD), a ferro liquid crystal display (FLCD), and a liquid crystal on silicon (LCOS) image display device.

10. The apparatus of claim 1, wherein the controller finds a distance from the imaging position to the nodal point formed before the imaging position using a projection distance from the two or more projection optical systems to the imaging position, a size of an image at the projection lenses provided in the two or more projection optical systems, and a size of an image at the imaging position, and performs control such that the light radiated from the two or more projection optical systems passes through any one point formed before the imaging position.

11. The apparatus of claim 10, wherein a distance DI from the imaging position to the nodal point formed before the imaging position is found from the following Equation:
$$\overline{DI = \frac{\begin{matrix}PP \text{:} DP = PI \text{:} DI \\ ( D - DI ) \times PI\end{matrix}}{PP}} \\ \underline{DI = \frac{D \times PI}{( PP + PI )}} \qquad ( Equation )$$
where DP is the projection distance from the two or more projection optical systems to any one point formed before the imaging position, PP is the size of an image at the projection lenses provided in the two or more projection optical systems, and PI is the size of an image at the imaging position.

12. The apparatus of claim 1, wherein the controller merges and flattens the light radiated from the two or more projection optical systems, thereby minimizing crosstalk between the viewing points or minimizing a change in brightness of a viewing point image around a center of the viewing point.
